(19) United States
(12) Patent Application Publication
(10) Pub. No.: US 2003/0008625 A1
(43) Pub. Date: Jan. 9, 2003

(54) Microphone arrangement for mobile telephones

(75) Inventors: Alexander Paritsky, Modi'in (IL); Alexander Kots, Ashdod (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Phone-Or Ltd.

(21) Appl. No.: 10/187,363

(22) Filed: Jul. 2, 2002

(30) Foreign Application Priority Data
Jul. 5, 2001 (IL) 144161

(51) Int. Cl. H04B 1/38

(52) U.S. Cl. 455/90; 455/575

(57) ABSTRACT

A mobile telephone including a microphone and an electronic component board for transmitting, receiving and processing of audio and other communication signals, said telephone comprising a housing portion˜an optical microphone, including a microphone head disposed in said housing portion; at leasl two light guides, one leading to a source of light and the other to a photodetector, said source of light feeding light into one of said light guides, said other light guide leading to an input of said photodetector, and an input of said source of light and an output of said photodetector being connected to the input of said electronic component board.

This Application claims the benefit of priority from IL Patent Application No. 14416 1, filed Jul. 5, 2001.

### FIELD OF THE INVENTION

The present invention relates to mobile telephones and, in particular, to mobile telephones having optical microphones.

### BACKGROUND OF THE INVENTION

All mobile telephones use a radio transmitter, which is a source of very high radio frequency interference (RFI). RFI has an adverse influence on all of the electronic circuits of a mobile telephone, but especially on the audio signal circuits. Efforts to counteract RFI require the use of special filtering elements and circuits and/or special shielding measures, as well as a particular method of guiding audio signals from the microphone to the signal processor of the telephone, such as the well-known “e-gold” connection technique, whereby connections are effected through an electronic component board. All of these measures, however, eventually lead to increased production costs.

### SUMMARY OF THE INVENTION

It is therefore a broad object of the present invention to provide a mobile telephone that will not require any special measures for avoiding RFI in audio channels, consequently costing less to produce than an ordinary mobile telephone.

It is another object of the present invention to provide a mobile telephone that senses audio signals by optical means, transforms the audio signals into optical signals, and transmits them directly to the signal processor of the telephone, eliminating the need for other measures to prevent RFI interference and drastically diminishing the cost of all of the audio systems of the telephone.

The invention thus provides a mobile telephone including a microphone and an electronic component board for transmitting, receiving and processing of audio and other communication signals, said telephone comprising a housing portion˜an optical microphone, including a microphone head disposed in said housing portion; at leasl two light guides, one leading to a source of light and the other to a photodetector, said source of light feeding light into one of said light guides, said other light guide leading to an input of said photodetector, and an input of said source of light and an output of said photodetector being connected to the input of said electronic component board.

### BRIEF DESCRIPTION OF THE DRAWINGS

The invention will now be described in connection with certain preferred embodiments, with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross-sectional view of a portion of a mobile telephone having an optical microphone according to the present invention;

FIG. 2 is a cross-sectional view of a mobile telephone having a further embodiment of an optical microphone attachment inside the telephone housing;

FIG. 3 is a cross-sectional view of a portion of a mobile telephone having an optical microphone disposed in a movable portion attached to the telephone housing, and

FIG. 4 is an electronic circuit diagram of a background noise suppression system for a mobile telephone having an optical microphone.

### DETAILED DESCRIPTION

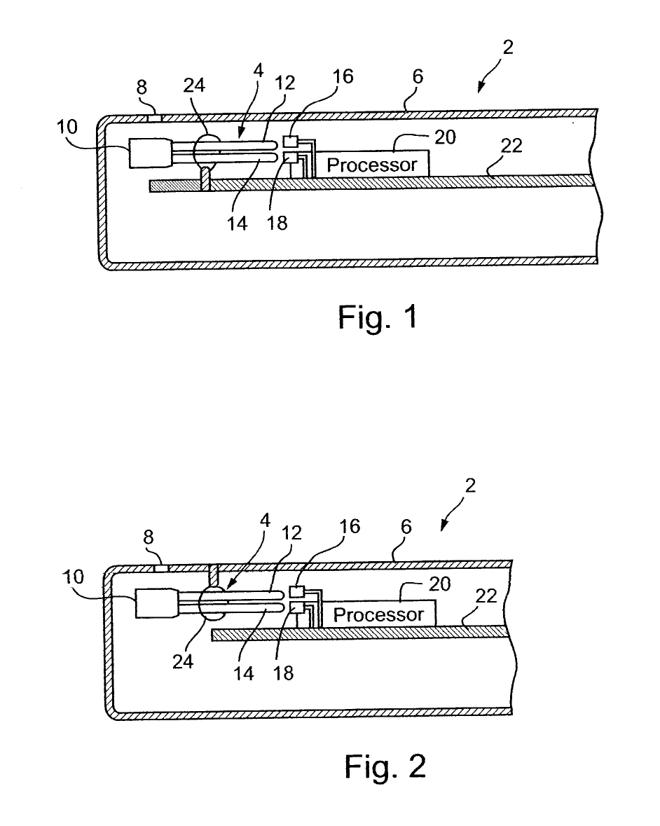

FIG. 1 illustrates a portion of a mobile telephone 2 fitted with an optical microphone 4 in accordance with the present invention. Specifically, there is shown the upper cover 6 of the telephone housing, having an acoustical signal input aperture 8, an optical microphone head 10 including an acoustical membrane (not shown) and light guides 12, 14. The light guides 12, 14 extend towards a source of light 16 and a photodetector 18 electrically connected to an audio processor 20 of the telephone. Processor 20, as well as source of light 16 and photodetector 18, are mounted on an electronic board 22. Light guides 12, 14 and microphone head 10 are affixed onto board 22 by means of clips 24. By this construction, the entire optical microphone 4 is attached to the electronic board 22. Photodetector 8 is placed adjacent to processor 20, and thus does not require any special shielding and filtration.

Sound entering through aperture 8 in housing upper cover 6 travels directly to microphone head 10, and is there transformed into modulated light signals. The modulated light signals are then guided to photodetector 18, which transforms them into electrical signals that are fed to audio processor 20. All along their way from input aperture 8 and up into audio processor 20, the signals are not influenced by any RFI, and thus do not require any RFI filtration or shielding. By means of optical guides, the audio signals may be brought to any point on the electronic board.

The utilization of an optical microphone in the above-described manner also eliminates the need for assembling all of the microphone elements in the upper cover of the telephone housing, as is the case when ordinary electrete microphones are used.

The construction of the present invention also possesses a further advantageous characteristic, in that all of the working parts of the telephone are placed on the electronic board. The entire telephone may thus be assembled and completely tested before it is finally encased in its housing.

FIG. 2 illustrates a modification of the invention in which, instead of attaching the microphone head 10 and light guides 12, 4 to board 22, these components are affixed to the upper cover 6 by means of a clip 24

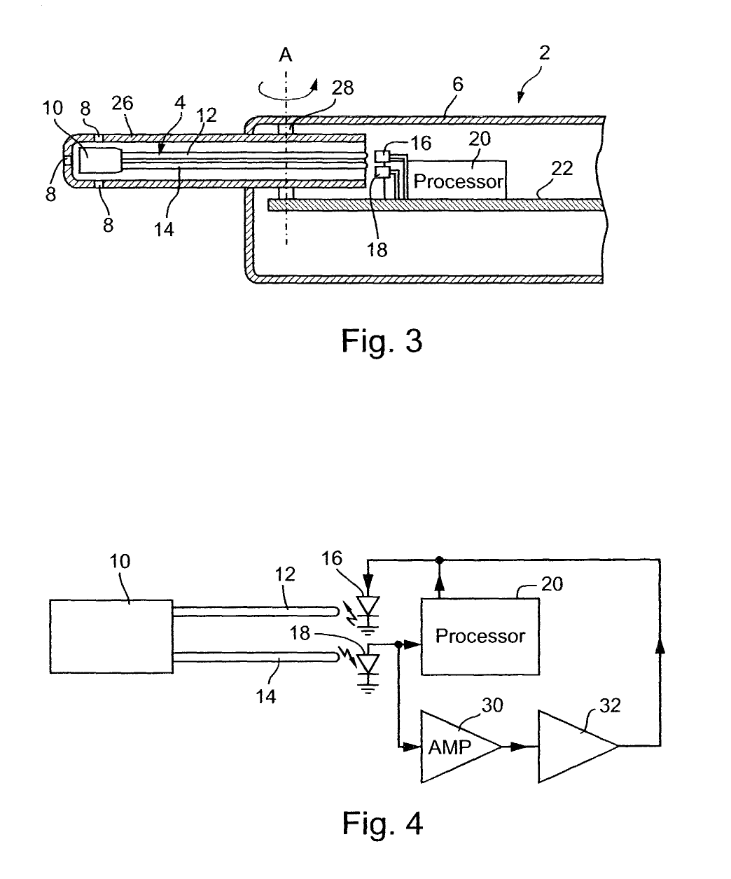

FIG. 3 shows a modification of the embodiment of FIG. 1, in which the mobile telephone 2 is furnished with an optical microphone 4, partially placed in a housing portion 26 pivotally attached to upper cover 6 at 28; thus facilitating its movement about axis A, as indicated by the arrow The light guides 12, 14 make optical contact with the source of light 16 and photodetector 18 only when housing portion 26 is in the operating position shown. Only the microphone head 10 and light guides 12, 14 are disposed inside movable housing portion 26, while the source of tight 16 and photodetector 8 are kept stationary inside housing 12 In this way, the active part of optical microphone 4 is placed outside the main portion of the mobile telephone, and only the microphone is brought closer to the speaker's mouth without increasing RFI, as compared to smaller mobile telephones wherein the microphones are removed further away from the speaker's mouth, resulting in voice signals which are weaker than background noises Housing portion 26 may be made like a tube; it may even be a mobile telephone antenna having one or more acoustical apertures 8 at the far end.

FIG. 4 is an electronic diagram of a background noise suppression system for a mobile telephone having an optical microphone. The electronic diagram of FIG. 4 includes a logarithmic amplifier 30, the input of which is connected to the output of the photodetector 18. The output of amplifier 30 is connected to the light source 16 through the circuit of a negative feedback circuit 32. Logarithmic amplifier 30 amplifies the output signals from photodetector 18. The amplification is very high for low output signals and is very low for high output signals. Over some predetermined levels, there is no signal amplification at all.

As a rule, all noises at the microphone input are weaker than the speaker's voice. It is possible to determine a specific level characterizing the speaker's voice level. All sounds below this level may be attributed to, or related to, noise, and all sounds over this level may be attributed to the speaker's voice. F or noise, the amplification is very high; all of the noise signals through circuit 32 will arrive at the input of the source of light 16 as negative feedback signals, thus diminishing the light intensity produced by source of fight 16 and diminishing the microphone's sensitivity to noise. For voice, the amplification is very low; all of the voice signals through negative feedback circuit 32 will arrive at the input of the source of light 16 at a very low level and will not change the light intensity produced. Hence, the sensitivity of the optical microphone for voice does not change. In this manner, the optical microphone suppresses undesirable noise, while simultaneously improving the quality of the speaker's voice.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A mobile telephone including a microphone and an electronic component board for transmitting, receiving and processing of audio and other communication signals, said telephone comprising:
a housing portion;
an optical microphone, including a microphone head disposed in said housing portion;
at least two light guides, one leading to a source of light and the other to a photodetector, said source of light feeding light into one of said light guides, said other light guide leading to an input of said photodetector; and
an input of said source of light and an output of said photodetector being connected to the input of said electronic component board.

2. The mobile telephone as claimed in claim 1, wherein said optical microphone head comprises an acoustic responsive membrane and said head is located adjacent to at least one sound opening in said housing portion, thereby transforming acoustical signals entering said opening into light intensity modulated signals.

3. The mobile telephone as claimed in claim 1, wherein said microphone head and said light guides are attached to said electronic component board.

4. The mobile telephone as claimed in claim 1, wherein said microphone head and said light guides are attached to said housing portion.

5. The mobile telephone as claimed in claim 1, wherein said optical microphone is affixed to said electronic component board or said housing portion by means of clips.

6. The mobile telephone as claimed in claim 2, wherein said microphone head and said light guides are placed in a pivotable part of said housing portion, the arrangement being such that, in an operational state, optical contacts are formed between said light guides, said source of light and said photodetector.

7. The mobile telephone as claimed in claim 1, further comprising a logarithmic amplifier connected to the output of said photodetector, the output of said logarithmic amplifier being connected through a negative feedback circuit to said source of light;
whereby low signals at the output of said photodetector undergo high amplification and high signals at the output of said photodetector undergo low amplification, said signals being fed to said light source in a phase opposite to that of the signals of said photodetector.

8. A mobile telephone as claimed in claim 1, substantially as hereinbefore described and with reference to the accompanying drawings.
